(19) United States
(12) Patent Application Publication
(10) Pub. No.: US 2009/0247194 A1
(43) Pub. Date: Oct. 1, 2009

(54) System and method for transmitting messages between a platform and a set of terminals

(75) Inventors: Aline Tarrago, Sceaux (FR); Francois Cottin, Paris (FR); Michel Seiler, Neuilly-Sur-Seine (FR); Sylvie Heriard Dubreuil, Paris (FR); Frederic Falleta, Le Kremlin-Bicetre (FR); Guy Caminondo, Rouillon (FR); Cyrille Van Der Voort, Courbevoie (FR); Thierry Sayd, Paris (FR); Aissatou Barry, Paris (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 11/887,157

(22) PCT Filed: Mar. 22, 2006
(86) PCT No.: PCT/FR2006/050247

§ 371 Date: Sep. 24, 2007

(30) Foreign Application Priority Data
Mar. 22, 2005 (FR) 05 02802

(51) Int. Cl. H04W 4/12

(52) U.S. Cl. 455/466

(57) ABSTRACT

A method for transmitting messages over a telecommunications network between a service platform (100) and at least one identified set of terminals (10, 21, 22, 31, 32), wherein said method comprises the steps of: defining at least one communication device (10) including said set of terminals, said device corresponding to a subscriber to said service platform (100) and associated with said set of identified terminals (10, 21, 22, 31, 32), for said communication device (10); receiving from the platform (100) at least one message originating from at least one referenced sending entity (310, 320); and transmitting to said platform (100) at least one instruction to transmit said message to at least one receiving terminal belonging to said identified set (10, 21, 22, 31, 32), said transmission instruction including at least one criterion of accessibility to a message in order to carry out a personalized redirection.

The present invention relates to a system and a method for transmitting messages over a telecommunications network between a service platform and at least one predefined set of terminals.

The invention finds a particularly advantageous application in the field of secure and personalized transmission of messages to receiving terminals from a communication device.

The prior art teaches of means for redirecting messages, such as telephone call transfer systems which make it possible to redirect to a predetermined terminal a message received on another terminal.

However, these known redirection means usually have the disadvantage of systematically redirecting all the messages without taking account of possible access conditions, such as the personal, confidential or, on the other hand, collective character of the messages.

In this sense, it is possible to evoke mail distributed by postal means amongst which it is possible to distinguish:
collective mail deposited in mailboxes with no mention of their intended recipients, such as advertisements, that can be accessed by all people authorized to open said mailboxes,
personal mail whose content can be accessed only by their intended recipient, even if the very existence of this mail may be known to people authorized to open the mailboxes,
confidential mail, usually given to their intended recipient by hand, whose existence and content are known only to said intended recipient.

It will be noted nevertheless that the distribution of this type of mail is carried out in bulk, that is to say in one and the same box, without distinction of their various intended recipients, the sorting being carried out by the intended recipients themselves. Similarly, no check is made of the observance of confidentiality.

Also, a technical problem to be solved by the subject of the present invention is to propose a method for transmitting messages over a telecommunications network between a service platform and at least one predefined set of terminals, which would make it possible to remedy the disadvantages of the existing systems and would allow a redirection of said messages only to their sole intended recipient(s) while also taking account of their access conditions.

The solution to the technical problem consists, according to the present invention, in that said method comprises the steps consisting in:
defining at least one communication device included in said set of terminals, said device corresponding to a subscriber to said service platform and associated with said set of identified terminals,
   for said communication device,
receiving from the platform at least one message originating from at least one referenced sending entity,
transmitting to said platform at least one instruction to transmit said message to at least one receiving terminal belonging to said identified set, said transmission instruction including at least one criterion of accessibility to a message.

According to the invention, said set of terminals is predefined by at least one manager entity of said set.

Similarly, the invention provides that said criterion of accessibility is defined by said manager entity.

Therefore, the method according to the invention allows the redirection of multimedia messages of any nature (text, audio, video, audiovisual, SMS (Short Message Service) or MMS (Multimedia Message Service), still or moving pictures, etc.) to terminals of any type (fixed or mobile telephones, personal computers or PCs, laptop computers, personal digital assistants or PDAs, television sets, etc.) predefined by the manager entity of the set of terminals. Access to the system may also be multiple, from a particular communication device, via electronic mail, via the Internet network, etc.

The method according to the invention also takes account of the access conditions of each message since, according to the invention, said criterion of accessibility is a free accessibility to the content of said message, or since said criterion of accessibility is a personal accessibility to the content of said message, or else since said criterion of accessibility is a confidential accessibility to said message.

An advantageous feature of the method according to the invention consists in that it also comprises a step of filtering of said message by said platform.

Advantageously, said filtering step comprises a step of verifying referencing of said entity sending said message to said set.

The invention also relates to a system for transmitting messages over a telecommunications network between a service platform and at least one predefined set of terminals, characterized in that said system comprises at least one communication device, included in said set of identified terminals, capable of receiving from the platform at least one message originating from at least one referenced sending entity, and of transmitting to said platform at least one instruction to transmit said message to at least one receiving terminal belonging to said identified set, said transmission instruction including at least one criterion of accessibility of said receiving terminal to a message.

Furthermore, the invention provides that said platform comprises at least one means of filtering of said message.

More precisely, said filtering means is a means of verifying referencing of said entity sending said message to said set. In particular, said referencing is determined by said manager entity.

It is understood that, in this manner, the system that is the subject of the invention makes it possible to eliminate any message originating from an unauthorized, namely unreferenced, source. The sources or sending entities are authorized by referencing on the initiative of the manager entity itself, which ensures a very high security of the set of terminals in question with respect to the intrusion of senders of undesirable messages.

The following description with respect to the appended drawings, given as nonlimiting examples, will clearly explain what is involved in the invention and how it can be embodied.

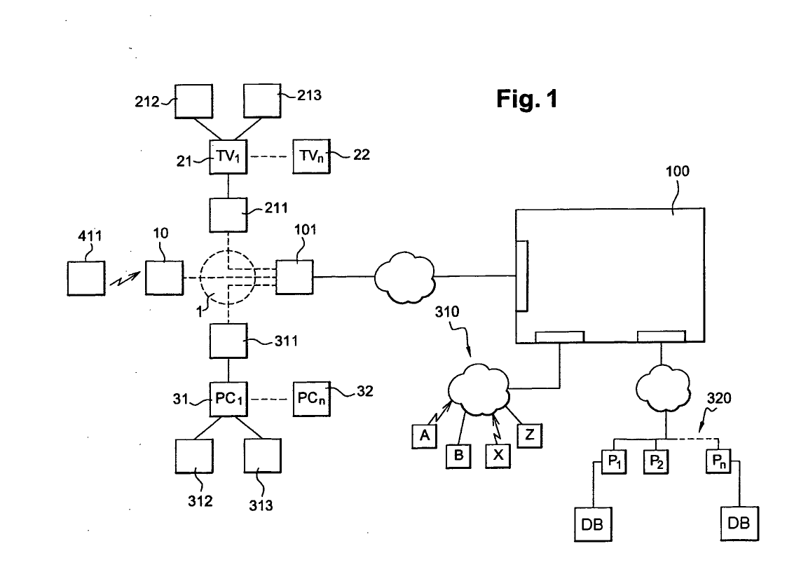

FIG. 1 is a diagram of a system for transmitting messages according to the invention.

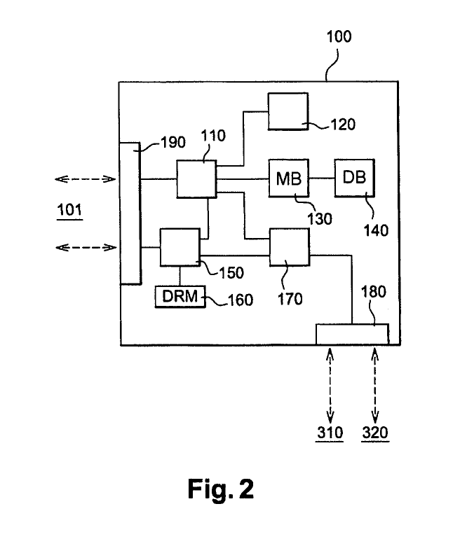

FIG. 2 is a detailed diagram of the platform of the system of FIG. 1.

FIG. 1 represents a system for transmitting messages over a telecommunications network between a platform 100 and at least one predefined set of terminals 10, 21, 22, 31, 32.

As shown in FIG. 1, the set of said terminals forms a local network 1 which may be, for example, a domestic network whose users are the members of one and the same family, or else an associative network, etc. This network, or set, is connected to the platform 100 over a telecommunications network via a specific gateway 101. The communication between the service platform 100 and the set of terminals is carried out via the gateway 101 and the communication interface 190 via a high bit rate cable, for example by high bit rate ADSL (Asymmetric Digital Subscriber Line) transmission. The messages sent by the platform 100 to the set of terminals are received on a particular terminal 10, called a communication device.

In the embodiment of FIG. 1, there are, particularly amongst the terminals forming said set, in addition to the communication device 10, terminals 21, 31 equipped with transmission and reception communication interfaces 211, 311, with a fixed link or short range radio link such as WiFi, WiMax, Bluetooth, etc. In particular these are television sets 21, 22 or personal computers 31, 32, equipped where necessary with a microphone 212, 312 and a camera 213, 313.

Terminals (not shown) may also be laptop computers, personal digital assistants or PDAs, etc., equipped with a compatible application for communication with said communication device 10. Other terminals, fixed or mobile telephones may be used with no interface, because they have direct fixed or mobile connection with the communication device 10.

The set of terminals is predefined by a manager entity which may be the user of the communication device 10. The terminals of said set are known and referenced on the platform 100. Said manager entity carries out the referencing of all the terminals forming said set. Said manager entity places in memory the list of the various terminals associated with the communication device 10. For each of the terminals, the terminal type (fixed or mobile telephones, television sets 21, 22, personal computers 31, 32, etc.) is specified. Similarly, the various users of the set of terminals and at least one terminal of said set allocated to each of the users are referenced.

Then, the manager entity identifies all the terminals of the set in order to allow a nondeclarative and automatic authentication of each of the terminals. Each of the terminals of the set is identified by a different identification depending on the type of terminal. In particular, the communication device 10 is identified by the fixed telephone number to which it is connected by the telecommunications operator by means of the copper pair or optical connection cable. A mobile terminal is for example identified by a memory card, such as a SIM (Subscriber Identity Module) card or a USIM (Universal Subscriber Identity Module) card or a UICC (UMTS IC Card), etc., which manages the security of said terminal thanks to operator signaling messages that are transparent to the user, or else by an MSISDN (Mobile Subscriber ISDN) number of the mobile terminal. A smart card or a standardized UICC card may identify each of the referenced terminals of the set, such as a television set 21, 22, a personal computer 31, 32, etc. This memory card may be put in place in the communication interface 211, 311 of the terminal.

The implicit authentication may be compatible with the recommendations of the Liberty Alliance enterprise consortium or else the single authentication technologies such as Single Sign-On (or SSO) or any other nondeclarative authentication.

The manager entity of said set of terminals may be the user of the communication device 10 and be identified as such on the service platform 100. But the referencing of the terminals and of the users may be carried out and placed in memory by the operator who manages the service platform 100. An external manager entity may, for example, be responsible for the referencing of the various sets of terminals.

Once the referencing has been carried out, said terminals of the set are recognized by the platform 100. As soon as one of said terminals is started up, the platform 100 detects the presence of said terminal in order to take account of a redirection to said terminal, for example from the transmission of instantaneous messages (such as Instant Messaging).

The messages transmitted by the platform 100 to the communication device 10 originate from various referenced sending entities which, as shown in FIG. 1, may be the terminals of said set or else different sets of terminals (not shown) or else the terminals corresponding to subscribers to the platform 100.

As shown in FIG. 1, when terminals A, B, . . . , X, Z of said set are situated outside the local network 1, they may enter into communication with the communication device 10 by means of the platform 100. Said terminals are equipped with an application compatible with said platform 100 and the communication device 10. They may make contact with said platform 100 by means of access providers 310 (mobile network, Internet network or any other communication network).

The sending entity may also be a provider 320 of services P1, P2, . . . , Pn capable of providing, for example, services of help or assistance to people, such as the police, maintenance or breakdown companies, health or medical services, administrative services such as the national employment agency, charities, etc. Said providers may be equipped with a communication device 10, or else an application, compatible for a communication with the platform 100, is installed in an item of equipment or terminal of said provider. Said application allows access to the services and the functionalities of the platform 100, and to the communication devices 10 of said sets.

Messages may also be sent from the various terminals of said set, including the communication device 10, to said set of terminals 10, 21, 22, 31, 32, or to the terminals corresponding to subscribers to the platform 100 or else to providers 320.

All of said communication devices 10 or applications compatible with said platform 100 allow access to the information placed in memory by the platform, such as said set of terminals, said access criteria, etc. corresponding to said communication device 10.

Outside the subscribers to said platform 100, access to other entities or other services or other networks, etc. is possible and entirely free, equivalent to a normal item of telecommunications equipment.

After receipt of the messages originating from at least one referenced sending entity via the platform 100, the communication device 10 of said set of terminals transmits to the platform 100 instructions relating to the transmission of said messages to receiving terminals belonging to said identified set. For example, the communication device 10 may ask the platform 100 to broadcast an audiovisual content to one of the television sets 21, 31. This therefore involves the communication device 10 in carrying out a personalized redirection of the messages to terminals recognized by the system as being intended recipients of said messages.

In addition, the manager entity predefines at least one instruction for transmitting messages to the terminals according to the intended recipient of a message and the nature of the content of the messages that can be received on the terminal (text, audio/sound, audiovisual, SMS or MMS short message, etc.). Said instructions to transmit messages also take account of at least one criterion of accessibility to a message.

As mentioned above, the referencing of the terminals may for example be carried out by an operator as the manager entity, as can a list of the predefined transmission instructions. The user, like another manager entity, may then define the particular or other criteria of accessibility.

It is possible to envisage, for example, three criteria of accessibility to a message:
a free accessibility to a message for the messages whose content can be accessed collectively by all the users. As an example, a proposed audiovisual report broadcast by an audiovisual content provider with simultaneous participation in a debate,
a personal accessibility to a message whose content can be accessed only by the intended recipient of said message, such as a proposed meeting or an offer of employment,
a confidential accessibility to a message whose existence and the content of the message are known only by the intended recipient of said message, such as the transmission to a patient of the results of a medical examination.

The messages that have a free accessibility can be accessed freely from all the terminals of the set and by all the referenced users. Said messages are called “collective” messages because they can be accessed by all the referenced users of said set. In particular, they are automatically broadcast as soon as the communication device 10 is started up. For example, for voice messages, they are automatically broadcast vocally hands free by the loudspeakers of the communication device 10, and consequently can be heard by all the users present. In another embodiment, a “collective” voice or text message may be redirected to a referenced television set 21, 22 which already broadcasts an audiovisual message, either vocally on the loudspeakers or with a text strip on the television screen for a simultaneous communication (voice or text, in addition to the audiovisual broadcast). A manual remote control 411 also allows the manual redirection of a message from the communication device 10 to a terminal of said set.

The messages that have a personal accessibility are usually transmitted to the communication device 10 and/or to a terminal called “personal”, referenced by the manager entity as the intended recipient of a personal message for a defined user.

The messages that have a confidential accessibility are transmitted only to a terminal of said set that is referenced as the “confidential” terminal for the intended recipient of the message.

As the set of terminals associated with the communication device 10 is predefined by the manager entity of said set, at least one transmission instruction, including at least one criterion of accessibility of the receiving terminals to a message, is also defined by said manager entity. At least one terminal is defined by the manager entity as the “personal” terminal for a message called “personal” and as a “confidential” terminal for a message called “confidential” for each of the users.

In addition, in order to prevent the receipt of messages originating from undesirable senders, the service platform 100 comprises at least one message filtering means. Accordingly, the platform 100 comprises at least one database 140 in which the accredited sending entities, that is to say those whose messages will be transmitted by the platform to the communication device 10, are referenced, the messages originating from other sending entities being eliminated.

The filtering is therefore carried out by verifying the referencing of the message-sending entities in at least one database 140 of the service platform 100.

The manager entity of the set of terminals is also responsible for defining the referencing of the sending entities on the service platform 100.

According to FIG. 2, the service platform 100 is therefore responsible for the following functionalities, taken separately or in combination:
organization and administration, for example by at least one management module 110 and by at least one mailbox (MB) module 130, of at least one transmission instruction, in particular of at least one criterion of accessibility (free accessibility, personal accessibility, confidential accessibility) for at least one message originating from at least one referenced sending entity, private or a professional partner, 310, 320, with use of a corresponding redirection to at least one terminal of the set referenced by the manager entity,
control and filtering of at least one sending entity,
nondeclarative and automatic authentication, without intervention of the user, of all the terminals and of their users thanks to the fixed connection by copper pairs, to the mobile connection by SIM cards or MSISDN numbers, by UICC cards, etc. by means of said authentication module 150,
real-time monitoring of the communications, presences and redirections.

Said service platform 100 also allows the following functionalities, taken separately or in combination:
control by said management module 110 of all the manager entities that are subscribed to the platform 100 and of all the terminals predefined by each manager entity,
access to the services of at least one referenced sending entity, for example by means of the access interfaces 180, of at least one authentication module 150 and an access module 170,
management by said management module 110 of all the accesses irrespective of the network operator concerned and irrespective of the access network (voice messages, SMS or MMS short messages by radio, mail by electronic mail, Internet network, etc.) by means of at least one communication interface 190 and one access interface 180,
management of all the access rights, particularly the intellectual property rights by means of a DRM (Digital Rights Management) module 160, which contains the information for managing rights and access to content transmitted by the providers 320,
saving of all the information, for example by means of an archiving module 120 for producing statistics, so as to measure the use of the services provided,
placing in memory in at least one database 140 of the identification tables, of referencing, of the transmission instructions, in particular of the criteria of accessibility to a message, of the management and redirection rules, of the user tables.

Said communication device 10 is equipped with at least one user interface allowing viewing, via a touch-screen or a screen/keyboard with transmit and receive audio and text broadcasting means, said communication device 10 being capable of receiving from the platform 100 at least one message originating from at least one referenced, private or professional sending entity 310, 320, and for access to the services of the service platform 100.

The main functions of said communication device 10 are as follows, taken separately or in combination:
interface for access to at least one message taking account of at least one criterion of accessibility to said message,
communication interface(s) with the other terminals 21, 22, 31, 32 of the set,
receipt of simultaneous communications in voice or text or videophone mode (for example by means of the microphone equipment 212, 312 and camera equipment 213, 313),
detection of proximity of terminals, for example in the case of a confidential message that must be broadcast to a mobile terminal located in the same radio cell as said communication device 10,
detection of presence of users of the terminals, for example by a biometric device that detects the contact of the hand of one of the referenced users for starting up said communication device 10 and the automatic broadcasting of a “collective” message.

Said communication device also makes it possible to command the transmission of the messages to television sets 21, 22, personal computers 31, 32, etc. and to receive commands by at least one manual remote control 411 for starting up said communication device 10 or the manual redirection of a message from the communication device 10 to a terminal of said set.

During the first connection to the service platform 100, at least one communication device 10 included in the set of terminals and one manager entity of said set of terminals is defined.

A method for transmitting messages using the system of FIG. 1 comprises amongst other things the following steps, taken separately or in combination, consisting in:
connecting at least one manager entity that is subscribed to the communication platform 100, in particular by means of at least one communication device 10,
recognizing and authenticating the communication device 10, for example by an authentication module 150 of the platform 100 by means of a telecommunications line identified for the communication device 10.

In particular, the platform and the communication device make it possible, separately or in combination, to:
place in memory, in at least one indexed table of the platform 100, the list of the various users of the set of terminals associated with the communication device 10 (name, forename, role or function in the set of terminals) and the list of the various terminals of the set (fixed or mobile telephones, television sets 21, 22, voice or text messaging system, personal computers 31, 32) connected in a fixed or mobile manner to the telecommunications network or via short range links (WiFi, WiMax, Bluetooth, etc.),
referencing the terminals of the set for each receipt of a message according to at least one transmission instruction, either according to the nature of the messages (text, audio/sound, audiovisual, SMS or MMS short message, etc.), or according to the criterion of accessibility to said message (collective, personal or confidential) defined by the manager entity of said set of terminals 10, 21, 22, 31, 32,
identifying said terminals in order to authenticate them automatically on each connection (receiving or sending a message) thanks to a different identifier according to each terminal and according to its nature (fixed telephone number identified by the network operator by means of the connection cable of copper or optical pairs, mobile terminal identified by the SIM card and/or the MSISDN number, each referenced item of equipment such as a television set 21, a personal computer 31, etc. identified by a standardized identified UICC smart card, etc.).

In particular, the communication device 10 makes it possible, separately or in combination, to:
receive said message, after having recognized the criterion of accessibility to the message by the platform 100 in order to define the broadcasting mode and the viewing of said message,
controlling the receipt with the appropriate viewing, after a formatting or a conversion if necessary, according to the nature of the message and according to the recognized criterion of accessibility of the message on at least one of the referenced terminals of the set after nondeclarative and automatic authentication of the receiving terminal(s) belonging to said identified set.

In addition, the service platform 100 comprises means for verifying referencing of at least one referenced sending entity 310, 320, private or a professional partner, of the various messages to each set of terminals, for the filtering of said messages to be transmitted by the platform 100 to said set 10, 21, 22, 31, 32.

The system and the method, according to the invention, therefore allow the management and the broadcasting of multimedia messages of any kind to referenced and identified terminals 10, 21, 22, 31, 32, after an implicit authentication and an automatic filtering preventing any unauthorized message and any undesired intrusion. The service platform 100 manages the organization and administration of the collective, personal and confidential messages originating from private or professional users, with use of a corresponding redirection to users of the terminals of the set that are referenced by the manager entity, allowing an interactivity and an interoperability of all the terminals and of all the access networks.

The criteria of accessibility to a message allow a sorting according to the transmission instructions defined by a manager entity. The messages called “collective” are broadcast in real time and allow the use of the communication device 10 as an interactive mailbox. The response to a collective message is also broadcast to all the receiving terminals in order to achieve a real-time receipt as soon as the terminals are started up.

The user interface of the communication device 10 allows a specific and different viewing depending on the criteria of accessibility to a message. For example, the collective messages may be freely audible as soon as said communication device 10 is started up. They may also be viewed on the screen of said communication device 10. A message called “personal” is indicated only by its presence for each receiving user of said personal message. A different personalization may be provided according to the intended recipient and the existence of a personal message. As for the remote control 411, commands are provided for gaining access to the message and carrying out a manual redirection to one of the terminals of the set, television sets 21, 22, personal computers 31, 32, or else to particular applications such as a video application for example.

1-14. (canceled)

15. A method for transmitting messages over a telecommunications network between a service platform (100) and at least one identified set of terminals (10, 21, 22, 31, 32):
wherein said method comprises the steps of:
defining at least one communication device (10) included in said set of terminals, said device corresponding to a subscriber to said service platform (100) and associated with said set of identified terminals (10, 21, 22, 31, 32),
receiving at said communication device (10) from the platform (100) at least one message originating from at least one referenced sending entity (310, 320); and
transmitting from said communication device (10) to said platform (100) at least one instruction to transmit said message to at least one receiving terminal belonging to said identified set (10, 21, 22, 31, 32), said transmission instruction including at least one criterion of accessibility to a message in order to carry out a personalized redirection.

16. The method as claimed in claim 15, further comprising a step of filtering of said message by said platform (100).

17. The method as claimed in claim 16, wherein said personalized redirection is a function of the intended recipient and of the nature and content of said message.

18. The method as claimed in claim 15, wherein said set of terminals (10, 21, 22, 31, 32) is predefined by at least one manager entity of said set.

19. The method as claimed in claim 15, wherein said criterion of accessibility is a free accessibility to the content of said message.

20. The method as claimed in claim 15, wherein said criterion of accessibility is a personal accessibility to the content of said message.

21. The method as claimed in claim 15, wherein said criterion of accessibility is a confidential accessibility to said message.

22. A system for transmitting messages over a telecommunications network between a service platform (100) and at least one predefined set of terminals (10, 21, 22, 31, 32), wherein the system comprises at least one communication device (10), included in said set of identified terminals, capable of receiving from the platform (100) at least one message originating from at least one referenced sending entity (310, 320), and of transmitting to said platform (100) at least one instruction to transmit said message to at least one receiving terminal belonging to said identified set, said transmission instruction including at least one criterion of accessibility of said receiving terminal to a message in order to carry out a personalized redirection.

23. The system as claimed in claim 22, wherein said platform (100) comprises at least means of filtering of said message.

24. A platform for using the method as claimed in claim 15 and a system for transmitting messages over a telecommunications network between a service platform (100) and at least one predefined set of terminals (10, 21, 22, 31, 32), wherein the system comprises at least one communication device (10), included in said set of identified terminals, capable of receiving from the platform (100) at least one message originating from at least one referenced sending entity (310, 320), and of transmitting to said platform (100) at least one instruction to transmit said message to at least one receiving terminal belonging to said identified set, said transmission instruction including at least one criterion of accessibility of said receiving terminal to a message in order to carry out a personalized redirection;
wherein said platform (100) is configured for the organization and administration of at least one collective, personal, confidential message originating from at least one referenced sending entity (310, 320), with use of a corresponding redirection to the users of the terminals of the set that are referenced by the manager entity after at least one nondeclarative and automatic authentication of all the terminals (10, 21, 22, 31, 32) and of the users.

25. A communication device for using the method as claimed in claim 15 and a system for transmitting messages over a telecommunications network between a service platform (100) and at least one predefined set of terminals (10, 21, 22, 31, 32), wherein the system comprises at least one communication device (10), included in said set of identified terminals, capable of receiving from the platform (100) at least one message originating from at least one referenced sending entity (310, 320), and of transmitting to said platform (100) at least one instruction to transmit said message to at least one receiving terminal belonging to said identified set, said transmission instruction including at least one criterion of accessibility of said receiving terminal to a message in order to carry out a personalized redirection;
wherein said communication device (10) comprises at least one interface for accessing at least one message taking account of at least one criterion of accessibility to said message, and a communication interface with the other terminals (21, 22, 31, 32) of the set.

26. The communication device (10) as claimed in claim 25, wherein the communication device is configured at least for reception of simultaneous communications in voice or text mode.

27. The communication device (10) as claimed in claim 25, wherein the communication device is configured at least for the detection of proximity of terminals in the case of a confidential message.

28. The communication device as claimed in claim 25, wherein the communication device is configured at least for the detection of presence of the users of the terminals.
